(19) United States
(12) Patent Application Publication
(10) Pub. No.: US 2019/0347680 A1
(43) Pub. Date: Nov. 14, 2019

(54) COMPUTER-IMPLEMENTED METHODS OF GATHERING REAL-TIME PRODUCT PRICE DATA FROM A PLURALITY OF DISPARATE SOURCES

(71) Applicant: Price Brain LLC, Greenville, SC (US)

(72) Inventor: Barclay Layman, Greenville, SC (US)

(21) Appl. No.: 16/409,080

(22) Filed: May 10, 2019

Related U.S. Application Data
(60) Provisional application No. 62/670,414, filed on May 11, 2018.
(60) Provisional application No. 62/804,486, filed on Feb. 12, 2019.

(51) Int. Cl. G06Q 30/02; G06Q 50/00; G06F 16/955; G06F 16/583

(52) U.S. Cl. CPC G06Q 30/0206; G06Q 30/0201; G06F 16/583; G06F 16/955; G06Q 50/01

(57) ABSTRACT

A computer-implemented method of providing an integrated social media and shopping environment is described herein. In one embodiment, the method includes receiving via a computer a photographic image including at least one product, generating a computer-implemented model of the photographic image on the computer, training a machine learning estimator using the computer-implemented model, generating a set of social media tags corresponding to the at least one product based on the training, storing an association between the set of social media tags and the photographic image, and uploading the photographic image and the association to a social media platform.

### CROSS-REFERENCE TO RELATED APPLICATION(S)

This application claims priority to U.S. Provisional Patent Application Ser. No. 62/670,414, filed May 11, 2018, and to U.S. Provisional Patent Application Ser. No. 62/804,486, filed Feb. 12, 2019. The entire content of these applications is hereby incorporated by reference herein.

### BACKGROUND OF THE INVENTION

The internet has lowered barriers to entry in many fields including retail. The resulting increased number and diversity of competitors and products poses informational challenges to market participants.

### SUMMARY

One aspect of the invention provides for a computer-implemented method of providing an integrated social media and shopping environment and is described herein. In one embodiment, the computer-implemented method includes receiving via a computer a photographic image including at least one product, generating a computer-implemented model of the photographic image on the computer, training a machine learning estimator using the computer-implemented model, generating a set of social media tags corresponding to the at least one product based on the training, storing an association between the set of social media tags and the photographic image, and uploading the photographic image and the association to a social media platform.

This aspect of the invention can include a variety of embodiments.

In one embodiment, training the machine learning estimator can further include extracting data from the photographic image, determining a set of characteristics of the at least one product based on the extracted data from the photographic image, and updating the generated computer-implemented model based on the set of characteristics. In some cases, the extracted data includes a set of key-value-pair nodes corresponding to the at least one product. In some cases, generating the set of social media tags is based at least in part on the determined set of characteristics. In some cases, generating the set of social media tags further includes comparing the determined set of characteristics to a set of predefined keywords.

In one embodiment, updating the generated computer-implemented model further includes customizing at least one extractor script managed by the computer-implemented model.

In one embodiment, the photographic image is received from a social media account managed by a user. In some cases, the photographic image is downloaded from the social media account based on an activation of a synchronization procedure for the social media account.

In one embodiment, the method includes controlling a search engine to obtain a plurality of Internet search results based on one or more queries containing information from the updated computer-implemented model, controlling the machine learning estimator to generate a probability that the plurality of Internet search results relate to the at least one product in the photographic image, if the probability exceeds a pre-defined threshold, extracting data including a price from the Internet search result, and storing the extracted data from the Internet search result, including the price and a uniform resource locator (URL), in the computer-implemented model.

In some cases, generating the set of social media tags includes generating at least one social media tag including at least a forwarding link to a webpage selling the at least one product, a visual representation of the at least one product, or a combination thereof. In some cases, the visual representation is displayed over the uploaded photographic image when a social media user hovers a mouse pointer icon over the at least one product contained in the uploaded photographic image. In some cases, at least one social media tag includes a swipe-up function providing access to a website selling the at least one product, the method further including attaching the swipe-up function to a video uploaded to the social media platform.

Another aspect of the invention includes a computer-implemented method of providing an integrated social media and shopping environment, and is described herein. In one embodiment, the computer-implemented method includes receiving via a computer, identity information corresponding to at least one product, generating a computer-implemented model of the at least one product based on the identity information and on the computer, training a machine learning estimator using the computer-implemented model, controlling a search engine to obtain a plurality of Internet search results based on one or more queries containing information from the updated computer-implemented model, controlling the machine learning estimator to generate a probability that the plurality of Internet search results relate to the at least one product, if the probability exceeds a pre-defined threshold, extracting data including a price from the Internet search result, storing the extracted data from the Internet search result, including the price and a uniform resource locator (URL), in the computer-implemented model, and generating a graphical user interface displaying representations of at least one selected from the group consisting of a photographic image, a price, and a vendor for the at least one product.

This aspect of the invention can include a variety of embodiments.

In one embodiment, the method includes transmitting a predefined communication to a user based on the user activating a portal or webpage managed by the computer. In some cases, the method further includes receiving a response from the user, and communicating with the user via a set of predefined communications based on the received response. In some cases, at least one communication from the user includes the received identity information for the at least one product. In some cases, the method further includes selecting at least one electronic advertisement based on the received response or communications from the user, and uploading the at least one selected electronic advertisement to the portal or webpage managed by the computer.

In one embodiment, the method is implemented by at least an artificial intelligence (AI)-based web bot, wherein the AI-based web bot is managed by the computer.

In one embodiment, training the machine learning estimator further includes extracting data from the identity information, determining a set of characteristics of the at least one product based on the extracted data from the identity information, and updating the generated computer-implemented model based on the set of characteristics.

In one embodiment, the method further includes updating the model by periodically extracting data from Internet search results.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIGS. 1-3 depict computer-implemented methods of gathering real-time product price data from a plurality of disparate sources according to embodiments of the invention.

FIG. 4 depicts a system for gathering real-time product price data from a plurality of disparate sources according to an embodiment of the invention.

FIG. 5 depicts a graphical user interface for entering a model number for a product of interest according to an embodiment of the invention.

FIG. 6 depicts search results for one product of interest including Uniform Resource Locators (URLs) according to an embodiment of the invention.

FIG. 7 is a screenshot of the IMPORT.IO® website showing scheduled, historic, and aggregate information regarding extractors according to an embodiment of the invention.

FIG. 8 depicts a validated product model stored in the ALGOLIA® database indices according to an embodiment of the invention.

FIGS. 9A and 9B depict a graphical user interface displaying search results including price, selection of a result, and updating of a local price to match the price of the selected result according to an embodiment of the invention.

FIG. 10 depicts an object detection model for scraping a photographic image according to an embodiment of the invention.

FIG. 11 depicts extracted descriptive tags attached to a photographic image according to an embodiment of the invention.

FIG. 12 depicts a photographic image uploaded to a social media account according to an embodiment of the invention.

FIG. 13 is a screenshot of the IMPORT.IO® website showing a search page for products of interest according to an embodiment of the invention.

FIG. 14 is a screenshot of the IMPORT.IO® website showing a user selection of a product of interest according to an embodiment of the invention.

FIG. 15 is a screenshot of a compilation of social media photographs and corresponding products according to an embodiment of the invention.

FIG. 16 is a screenshot of a social media post with a link to purchase a corresponding product of interest according to an embodiment of the invention.

FIGS. 17 and 18 are screenshots of the IMPORT.IO® website showing a social media post and links to purchase a corresponding product of interest according to embodiments of the invention.

FIG. 19 is a screenshot of a website for a retailer selling a product of interest according of an embodiment of the invention.

### DEFINITIONS

The instant invention is most clearly understood with reference to the following definitions.

As used herein, the singular form “a,” “an,” and “the” include plural references unless the context clearly dictates otherwise.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

### DETAILED DESCRIPTION OF THE INVENTION

Embodiments of the invention provide computer-implemented methods of gathering real-time product price data from a plurality of disparate sources.

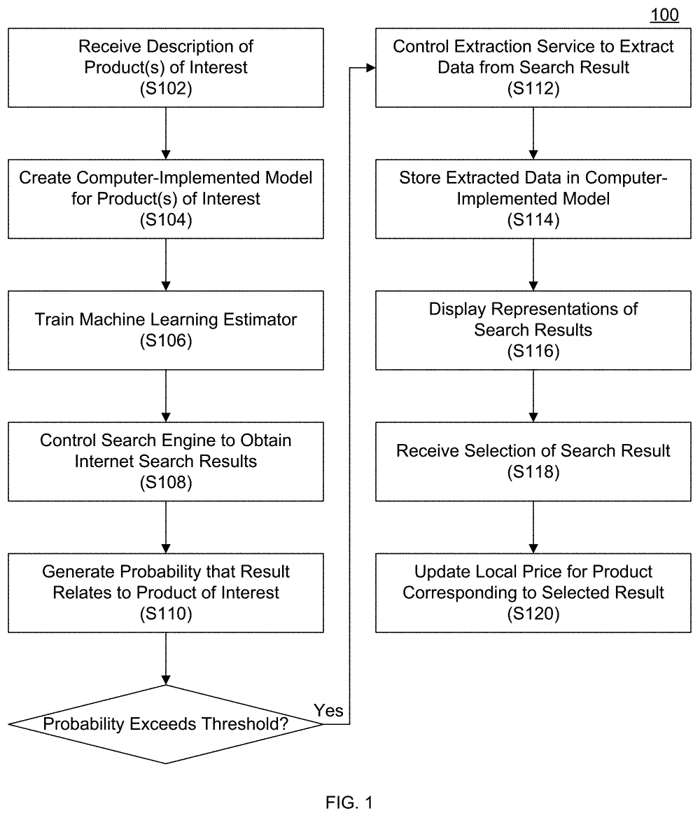

One exemplary method 100 is described and depicted in the context of FIG. 1.

In step S102, a description of one or more products of interest is received on a computer.

Embodiments of the invention can be implemented in whole or in part on a variety of computers including servers, personal computers, desktop computers, laptop computers, tablet computers, smartphones, and the like.

In one embodiment, the description includes at least a product number. The product number can be specified by the originator of the product (e.g., a manufacturer, distributor, and the like), assigned by a third party or a standard (e.g., Universal Product Codes, Stock Keeping Unit (SKU) codes, Global Trade Item Numbers (GTINs), International Article Numbers (EANs), and the like. The description can additionally or alternatively include a product name.

The description can be received in a variety of formats including as a submission in a graphical user interface form, in a computer file, and the like.

In step S104, a computer-implemented model is created for the products of interest. Initially, this computer-implemented model may only include the description received in step S102.

In step S106, a machine learning estimator is trained using the model one or more products of interested. Suitable machine learning estimators are available under the TENSORFLOW® trademark from Google Inc. of Mountain View, Calif.

“Training” can generate a pipeline of key-value pairs returned from product URLs that are scraped and then referenced against existing data. When an initial model reaches a composite score of 90% or other user-defined threshold, the system has matched the “key” (usually product model or SKU) from the unique URL returned from the search. Training cycles can stop collecting all datatypes that match existing model values in future runs except for a specific datatype which will equal price or equivocally named label.

As discussed above, the initial model may contain only a single product ID whereby “training” collects “variants” (e.g., color, size, etc.) during the process builds and establishes a “concrete model”, or composite score =predetermined %. The estimate is returned after an initial training run based on starting model data points.

In step S108, a search engine is controlled to obtain a plurality of internet search results based one or more queries containing information from the computer-implemented model. Exemplary search engines are available under the GOOGLE® trademark from Google Inc. of Mountain View, Calif. and under the BING® trademark from Microsoft Corporation of Redmond, Wash. In one embodiment, a script is controlled to execute a plurality of searches sequentially or in parallel.

In step S110, the machine learning estimator is controlled to generate a probability that the internet search results relate to the product of interest. Initially this probability may be close to binary, i.e., if the search result includes the product number, the estimator will consider it to have a close to 100% probability of relating the product of interest However, as the models are refined (e.g., based upon client input when reviewing competitive prices), the models may become more refined and the estimates more diverse.

In step S112, if the probability exceeds a pre-defined threshold (e.g., 90%), an extraction service (e.g., IMPORT.IO® available from Import.io of London, United Kingdom) is controlled to extract data include a price from the internet search result. For example, the URL can be passed to the extraction service. The extracted data can be received in a variety of formats including JSON (JavaScript Object Notation) objects, plain text, structured data, and the like.

In step S114, the extracted data is stored in the computer-implemented model.

In step S116, a graphical user interface displaying representations of the internet search results for the one or more products of interest. The representations can include images or text (e.g., price, vendor, description). The images can be generated through in-line linking to images stored on the scraped web pages. The representations can be arranged in a variety of formats including by vendor, sorting alphabetically or by price, and the like. The GUI can be displayed on a single-board computer or other computing device.

In step S118, a selection of an internet search result can be received. The selection can be made using any of a variety of GUI techniques including clicking (e.g., with a mouse or touchpad), touching (e.g., with a finger or stylus), navigating with a keyboard, and the like.

In step S120, a command to update a local price for the product of interest can be generated. The command can be internal (e.g., limited to the computer-implemented model) or can be external (e.g., directed to the client's e-commerce platform). In some embodiments, an internal update to the computer-implemented model is propagated externally by periodic access to the computer-implemented model by the client's e-commerce platform.

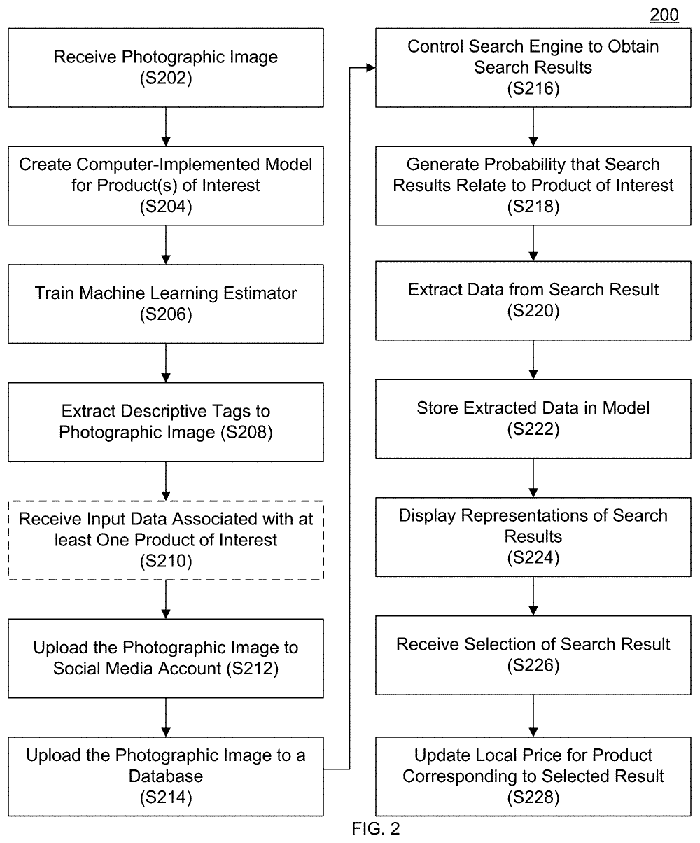

Another exemplary method 200 is described and depicted in the context of FIG. 2.

In step S202, a photographic image including at least one product of interest is received on a computer. Embodiments of the invention can be implemented in whole or in part on a variety of computers including servers, personal computers, desktop computers, laptop computers, tablet computers, smartphones, and the like.

In step S204, a computer-implemented model is created for the products of interest.

In step S206, a machine learning estimator is trained using the photographic image. Suitable machine learning estimators are available under the TENSORFLOW® trademark from Google Inc. of Mountain View, Calif.

“Training” can generate a pipeline of key-value pairs returned from the photographic image that is scraped and then referenced against existing data. Training cycles can stop collecting all datatypes that match existing model values in future runs except for a specific datatype which will equal price or equivocally named label.

In this case, “training” collects “variants” (e.g., color, size, etc.) from the photographic image and during the process builds, which establishes a “concrete model,” or composite score =predetermined %. The estimate is returned after an initial training run based on starting model data points. The machine learning estimator may store these variants within a computer-implemented model associated with the at least one product.

In step S208, an extracting service may be used to extract descriptive tags for the photographic image. The extracting service may receive the collected variants during training, and may determine a set of descriptive tags for the photographic image based on the variants. In some examples, the descriptive tags may be social media tags. The descriptive tags may be extracted from object code maintained by the extracting service. The descriptive tags may also be stored in the computer-implemented model.

In step S210, the system may attach the social media tags to the photographic image. In some cases, the social media tags are based on a set of characteristics determined for the product of interest. Additionally or alternatively, the social media tags may include a forwarding link to a webpage selling the product of interest, a visual representation of the product of interest, a swipe-up function that is separately attachable to a video clip, or a combination thereof. Additionally, a visual representation social media tag may be displayed over top of the photographic image based on a social media user hovering a mouse pointer icon over the product of interest contained in the photograph.

In step S212, the system may upload the photographic image with the descriptive tags to an online account. In some cases, the online account is a social media account. Additionally, the system may upload the photographic image with inputted data, such as a retailer's name.

In step S214, the system may upload the photographic image to a database. The photographic image may be uploaded along with the collected variants, the inputted data, and/or the descriptive tags associated with the photographic image. In some cases, the version of the photographic image that is uploaded to the online account is uploaded to the database.

In step S216, a search engine is controlled to obtain a plurality of internet search results based on one or more queries containing information associated with the photographic image. The one or more queries may be generated based on the variants, the descriptive tags, the input data, other information stored in the computer-implemented model, or a combination thereof. Exemplary search engines are available under the GOOGLE® trademark from Google Inc. of Mountain View, Calif. and under the BING® trademark from Microsoft Corporation of Redmond, Wash. In one embodiment, a script is controlled to execute a plurality of searches sequentially or in parallel.

In step S218, the machine learning estimator is controlled to generate a probability that the internet search results relate to the product of interest. Initially this probability may be close to binary, i.e., if the search result includes the product number, the estimator will consider it to have a close to 100% probability of relating the product of interest However, as the models are refined (e.g., based upon client input when reviewing competitive prices), the models may become more refined and the estimates more diverse.

In step S220, if the probability exceeds a pre-defined threshold (e.g., 90%), the extraction service (e.g., IMPORT.IO® available from Import.io of London, United Kingdom) is controlled to extract data include a price from the internet search result. The extracted data can be received in a variety of formats including JSON (JavaScript Object Notation) objects, plain text, structured data, and the like.

In step S222, the extracted data is stored in the computer-implemented model.

In step S224, a graphical user interface displaying representations of the internet search results for the at least one product of interest. The representations can include images or text (e.g., price, vendor, description). The images can be generated through in-line linking to images stored on the scraped web pages. The representations can be arranged in a variety of formats including by vendor, sorting alphabetically or by price, and the like. The GUI can be displayed on a single-board computer or other computing device.

In some cases, the displayed representations may be triggered by a display request. For example, a user may transmit a request for the representations by clicking on the uploaded photographic image on either the social media account or the photographic image stored in the database. The trigger can be made using any of a variety of GUI techniques including clicking (e.g., with a mouse or touchpad), touching (e.g., with a finger or stylus), navigating with a keyboard, and the like.

In step S226, a selection of an internet search result can be received. The selection can be made using any of a variety of GUI techniques including clicking (e.g., with a mouse or touchpad), touching (e.g., with a finger or stylus), navigating with a keyboard, and the like. Selecting the internet search result may cause the system to forward a browser session to a URL associated with the internet search result.

In step S228, a command to update a local price for the product of interest can be generated. The command can be internal (e.g., limited to the computer-implemented model) or can be external (e.g., directed from the client). In some embodiments, an internal update to the computer-implemented model is propagated externally by periodic access to the computer-implemented model by the client's platform.

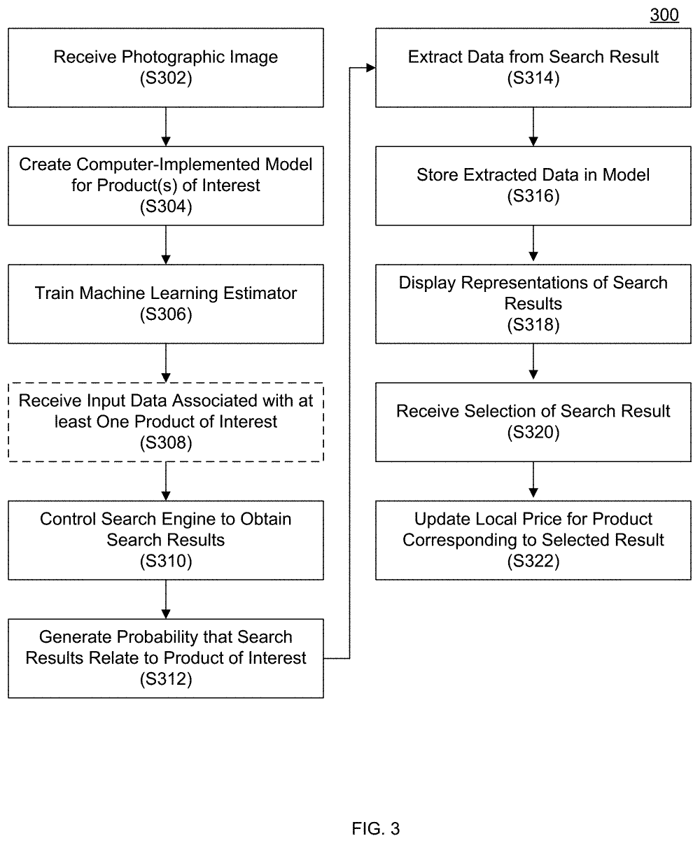

Another exemplary method 300 is described and depicted in the context of FIG. 3.

In step S302, a photographic image including at least one product of interest is received on a computer. Embodiments of the invention can be implemented in whole or in part on a variety of computers including servers, personal computers, desktop computers, laptop computers, tablet computers, smartphones, and the like.

In step S304, a computer-implemented model is created for the products of interest.

In step S306, a machine learning estimator is trained using the photographic image. Suitable machine learning estimators are available under the TENSORFLOW® trademark from Google Inc. of Mountain View, Calif.

“Training” can generate a pipeline of key-value pairs returned from the photographic image that is scraped and then referenced against existing data. Training cycles can stop collecting all datatypes that match existing model values in future runs except for a specific datatype which will equal price or equivocally named label.

In this case, “training” collects “variants” (e.g., color, size, etc.) from the photographic image and during the process builds, which establishes a “concrete model,” or composite score =predetermined %. The estimate is returned after an initial training run based on starting model data points. The machine learning estimator may store these variants within a computer-implemented model associated with the at least one product.

Optionally, in step S308, the system may receive input data associated with the at least one product. For example, the system may receive descriptive terms (e.g., a type of clothing, a retailer that sells the product, etc.) associated with the at least one product, or may receive a URL of a retailer selling the at least one product. The input data may additionally be stored in the computer-implemented model.

In step S310, a search engine is controlled to obtain a plurality of internet search results based on one or more queries containing information associated with the photographic image. The one or more queries may be generated based on the variants, the descriptive tags, the input data, other information stored in the computer-implemented model, or a combination thereof. Exemplary search engines are available under the GOOGLE® trademark from Google Inc. of Mountain View, Calif. and under the BING® trademark from Microsoft Corporation of Redmond, Wash. In one embodiment, a script is controlled to execute a plurality of searches sequentially or in parallel.

In step S312, the machine learning estimator is controlled to generate a probability that the internet search results relate to the product of interest. Initially this probability may be close to binary, i.e., if the search result includes the product number, the estimator will consider it to have a close to 100% probability of relating the product of interest However, as the models are refined (e.g., based upon client input when reviewing competitive prices), the models may become more refined and the estimates more diverse.

In step S314, if the probability exceeds a pre-defined threshold (e.g., 90%), the extraction service (e.g., IMPORT.IO® available from Import.io of London, United Kingdom) is controlled to extract data include a price from the internet search result. The extracted data can be received in a variety of formats including JSON (JavaScript Object Notation) objects, plain text, structured data, and the like.

In step S316, the extracted data is stored in the computer-implemented model.

In step S318, a graphical user interface displaying representations of the internet search results for the at least one product of interest. The representations can include images or text (e.g., price, vendor, description). The images can be generated through in-line linking to images stored on the scraped web pages. The representations can be arranged in a variety of formats including by vendor, sorting alphabetically or by price, and the like. The GUI can be displayed on a single-board computer or other computing device.

In some cases, the displayed representations may be triggered by a display request. For example, a user may transmit a request for the representations by clicking on the uploaded photographic image on either the social media account or the photographic image stored in the database. The trigger can be made using any of a variety of GUI techniques including clicking (e.g., with a mouse or touchpad), touching (e.g., with a finger or stylus), navigating with a keyboard, and the like.

In step S320, a selection of an internet search result can be received. The selection can be made using any of a variety of GUI techniques including clicking (e.g., with a mouse or touchpad), touching (e.g., with a finger or stylus), navigating with a keyboard, and the like. Selecting the internet search result may cause the system to forward a browser session to a URL associated with the internet search result.

In step S322, a command to update a local price for the product of interest can be generated. The command can be internal (e.g., limited to the computer-implemented model) or can be external (e.g., directed from the client). In some embodiments, an internal update to the computer-implemented model is propagated externally by periodic access to the computer-implemented model by the client's platform.

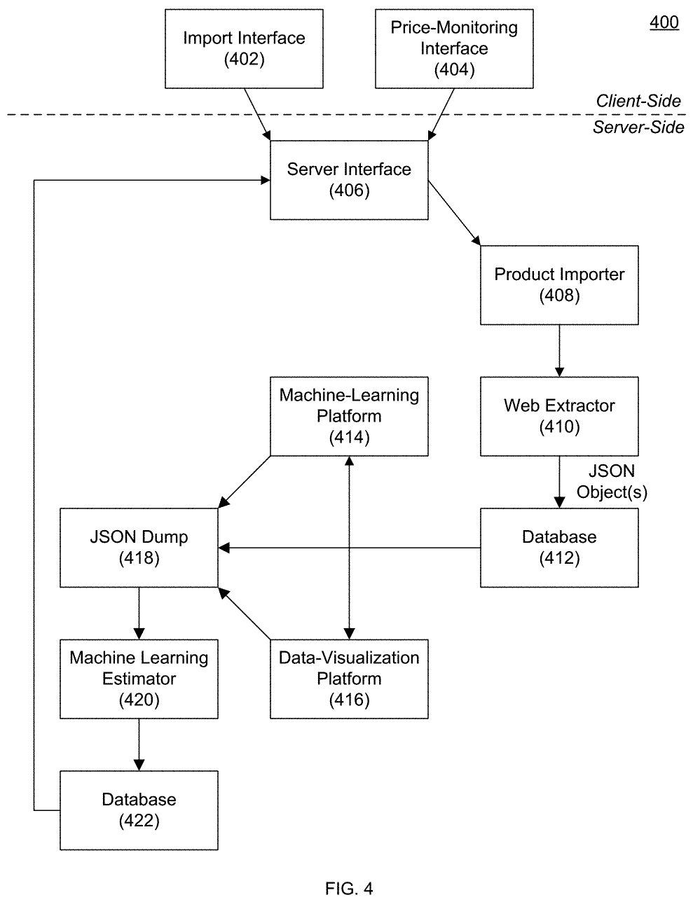

Referring now to FIG. 4, an exemplary system 400 is depicted. Import interface 402 and/or price-monitoring interface 204 can be displayed on a client computing device such as a special-purpose single-board computer or a general-purpose computer containing an appropriate application or web browser.

Import interface 402 and price-monitoring interface 404 can communicate with a server interface 406 programmed to receive information from the client and provide information to the client. Product importer 408 can be programmed to receive product information, e.g., in plain text, comma-separated value (CSV) files, and the like.

Web extractor 410 can be programmed to identify and extract information from internet content. The extracted content can be store in a database 412, from which it can be evaluated by machine-learning platform 414 and/or data-visualization platform 416, which can be further aggregated in data structure 418. If the aggregated data has more than a user-defined likelihood of relating to the product of interest by machine learning estimator 420, the data can be stored in another instance of a database 422, from where it can be accessed by server interface 406, e.g., for display by price-monitoring interface 404.

### WORKING EXAMPLE

### Exemplary Implementation

Aspects of the invention are further described in the context of a Software-as-a-Service (SAAS) application for gathering real-time product price data from across the web. This application utilizes machine learning and artificial intelligence (AI) to predict specific product site location(s) (e.g., as defined by Uniform Resource Locator or URL) and return the current listed price associated with a specific product.

The application includes a client-facing REACT™ web application for creating or importing existing client data (products) and managing models that are the starting point to training machine learning “estimators” using Google's open source TENSORFLOW® software. These probability results from matches across the search are garnered using an embedded GOOGLE® search request via a script call that are then returned as JSON (JavaScript Object Notation) objects where they are streamed into the GOOGLE® CLOUD DATAFLOW™ service. Data is then indexed and then queried using the GOOGLE® BIGQUERY™ data warehouse to match original model inputted data. Once the data and hosted URL parameters are validated, an extractor is created using an API call to the IMPORT.IO® service. The results of this query “validated product model” are then fed back into a POSTGRESQL™ database where it automatically updates a product feed API sent to a hosted SHOPIFY® store application as a single product. This “store” generates a list of products with collected prices from the URLs with tagged (e.g., price) data highlighted to showcase the competitor's lower price. URLs and product data are also fed and a custom index is created using the ALGOLIA® platform to enable legacy data price points to be archived.

A store URL (to a location containing aggregated information) can be consumed via a dedicated client device (e.g., a RASPBERRY PI® 3 single-board computer) running a custom operating system that launches a pre-configured URL in full-screen. The URL points to a webpage that displays store products scrolling in real-time. A connected touch-screen monitor enables a simple touch to a highlighted product to update the corresponding product's API that a client would consume to update the price for a specific product on its site (database). The client device is managed by a server-side application written in the PYTHON® programming language to constantly manage the device including whitelisted IP addresses and block ports, etc.

### Exemplary Workflow

Assume that a client wishes to ensure that a gas grill is competitively priced. The client specifies information regarding the particular gas grill (e.g., by navigating to the client's webpage for the gas grill, passing a URL for webpage, and the like). This product page contains all of the data needed to build an accurate product model over time, which embodiments of the invention will collect from the web after scraping this page a single time.

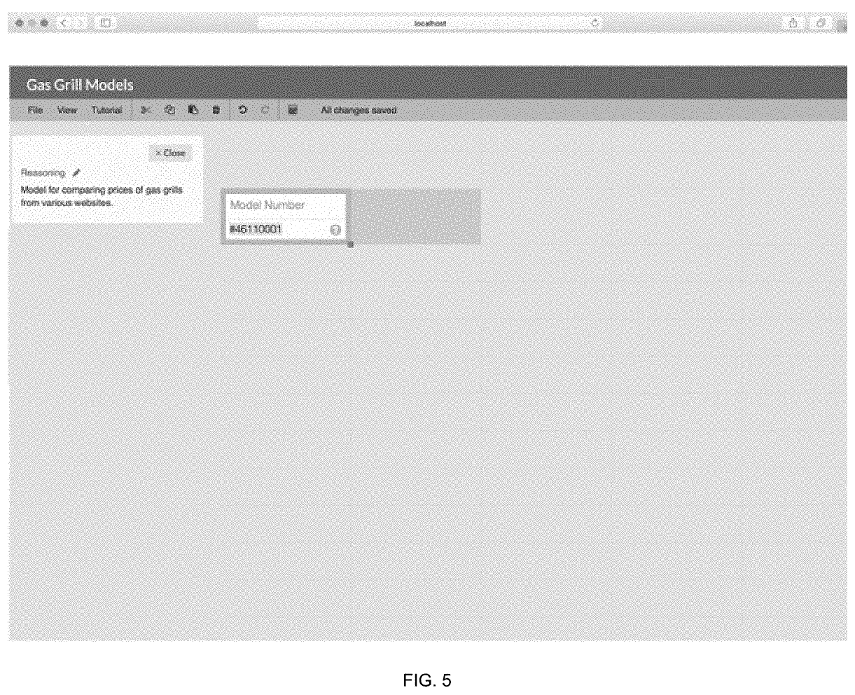

In FIG. 5, the client enters the model number for the particular gas grill in a graphical user interface. In many cases, the client will upload an existing CSV (comma-separated variable) file of the products that it wants to track. In still another case, one or more product types can be specified and the application can scrape data beginning with the specified product type(s) to build a starting model.

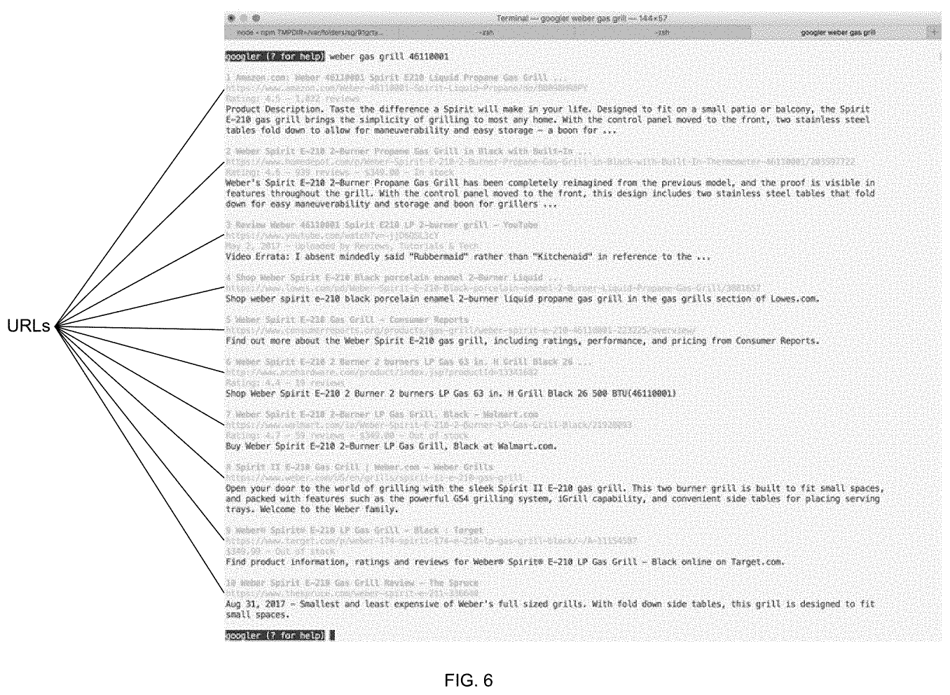

After entry into the application, a script call is made to the GOOGLE® search engine. FIG. 6 depicts search results for one product including URLs.

After validating a URL (which can be used as a key to a record containing the product model match), the IMPORT.IO® service is called via an API script and a new extractor is automatically created. Data returned is pushed to GOOGLE® CLOUD DATAFLOW™ via an IMPORT.IO® API.

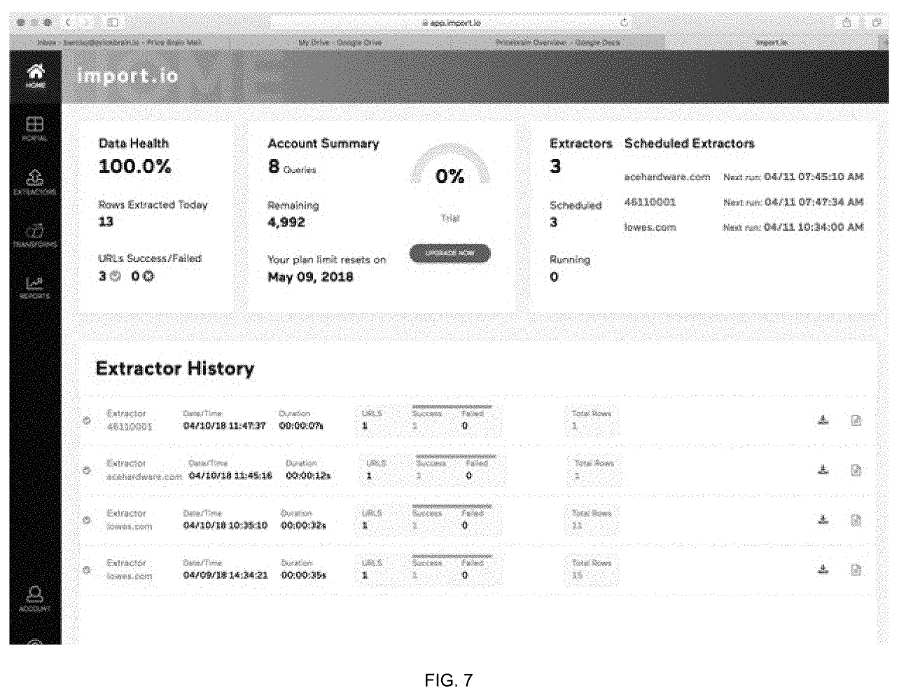

IMPORT.IO® extractors are scheduled to run at specific time intervals depending on client requirements. APIs can be utilized to create, monitor and schedule extractors. FIG. 7 is a screenshot of the IMPORT.IO® website showing scheduled, historic, and aggregate information regarding extractors. The application can iterate through a plurality of models.

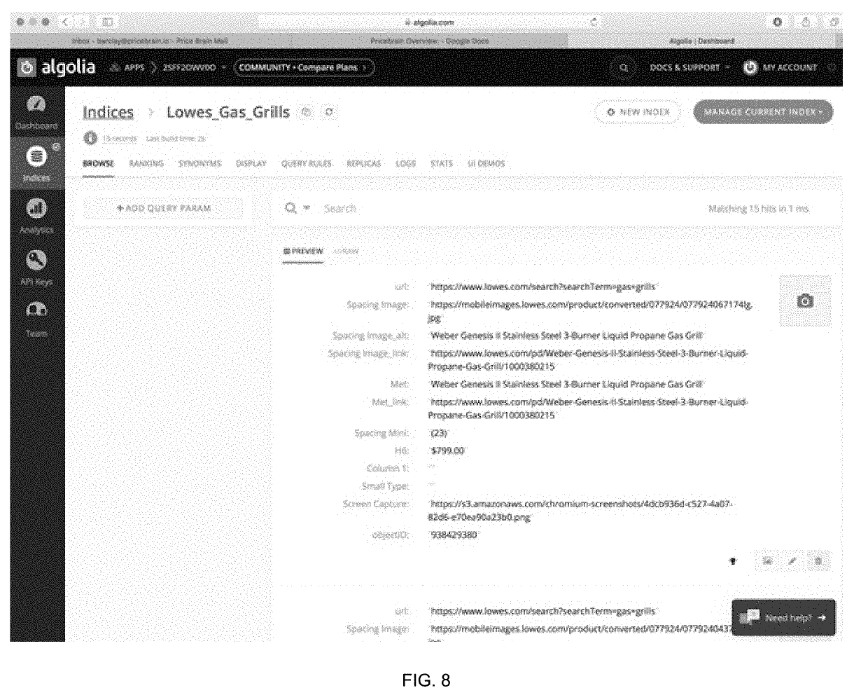

The extracted data is archived to generate a dataset to “train” the TENSORFLOW® software and build a product database to be used in the future. Currently, each returned validated product model is stored in the ALGOLIA® database indices as depicted in FIG. 8 for legacy data and to build a product archive.

A new “store” is created on-the-fly (e.g., using the SHOPIFY® service) with product data gathered from the above process with product variants such as URL referrer (competitor's site) and product price and is displayed. The “store” can operate on a private domain to protect data. In such an embodiment, the user will never have to type in a URL or log in.

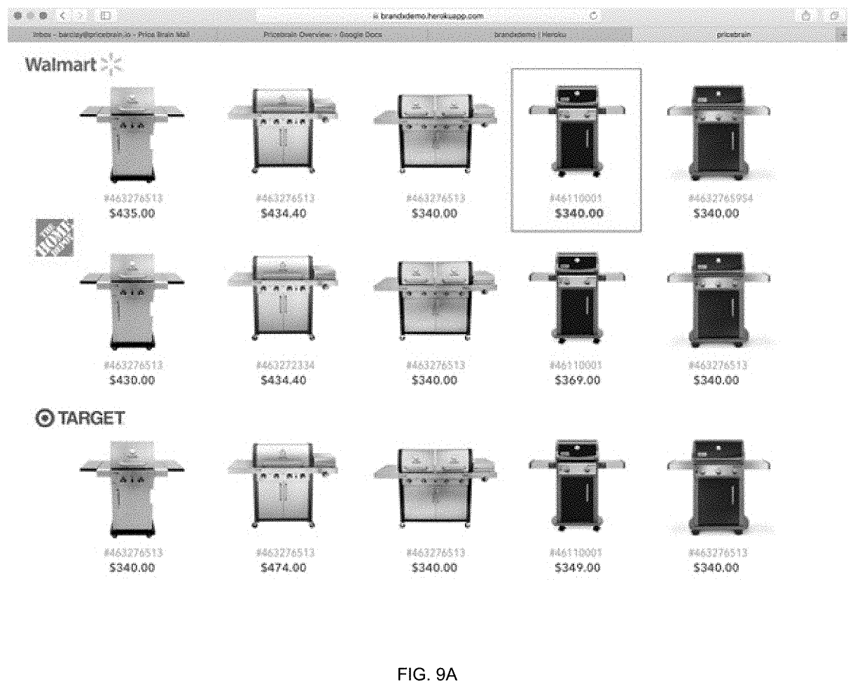

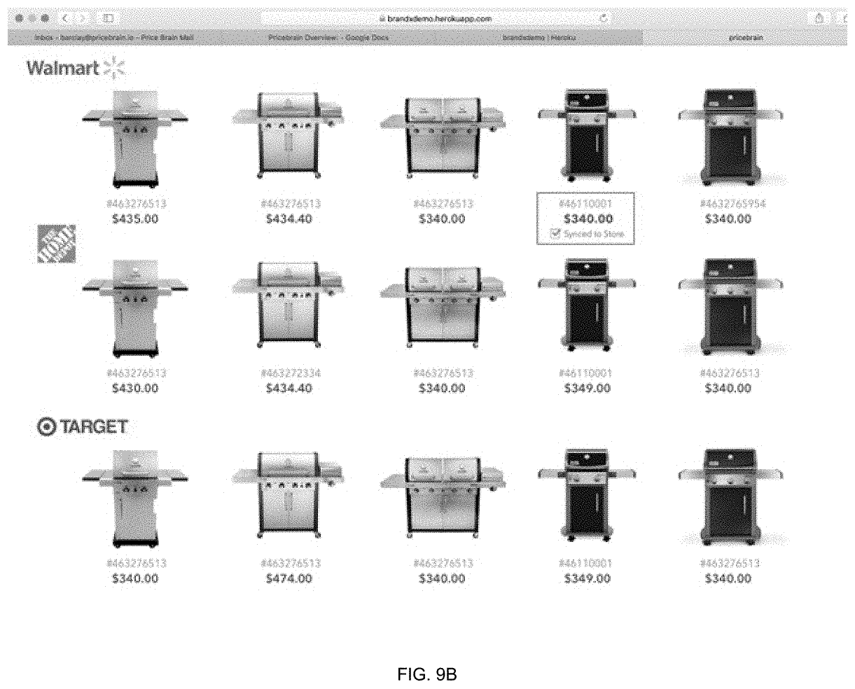

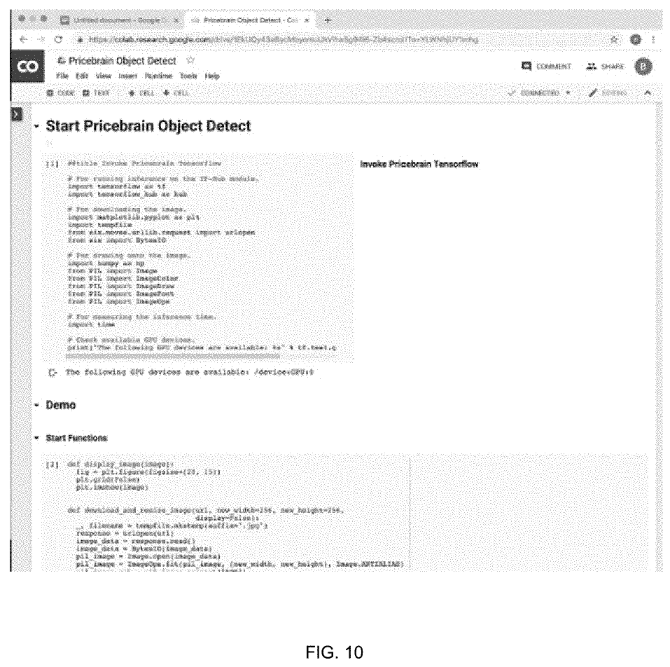

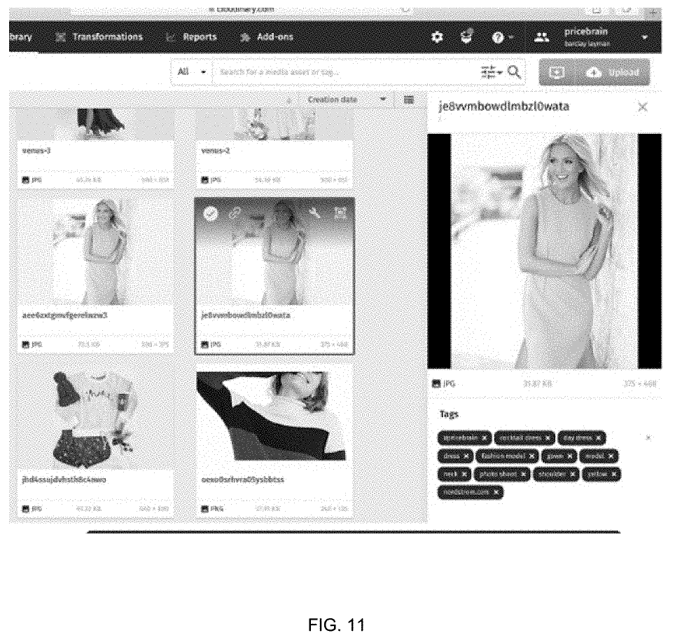

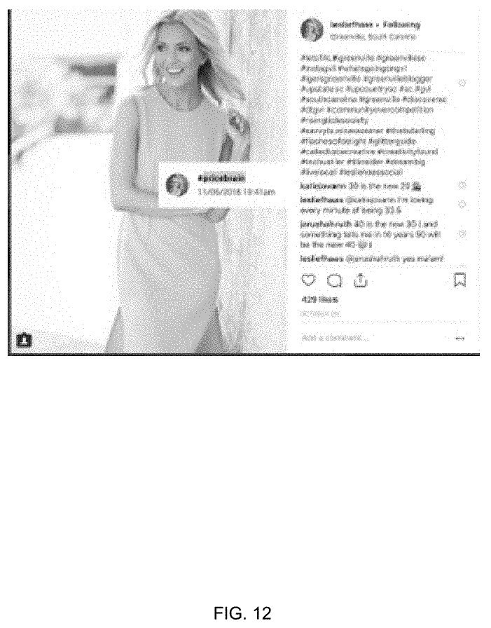

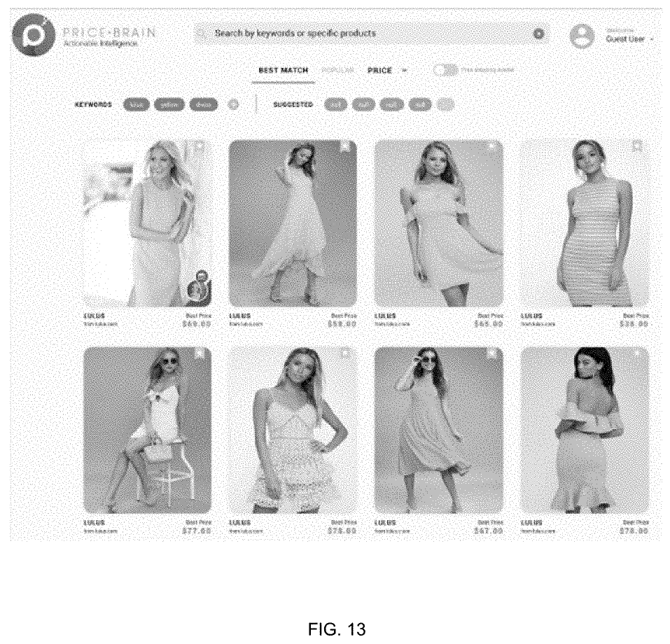

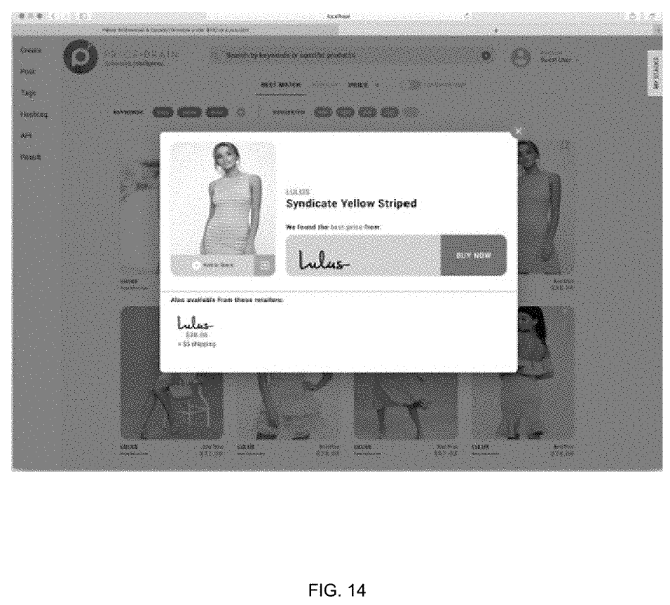

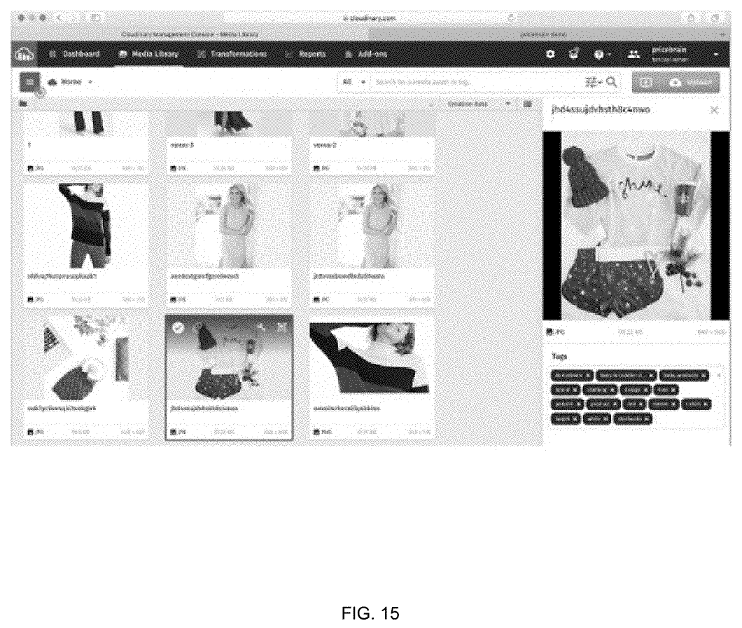

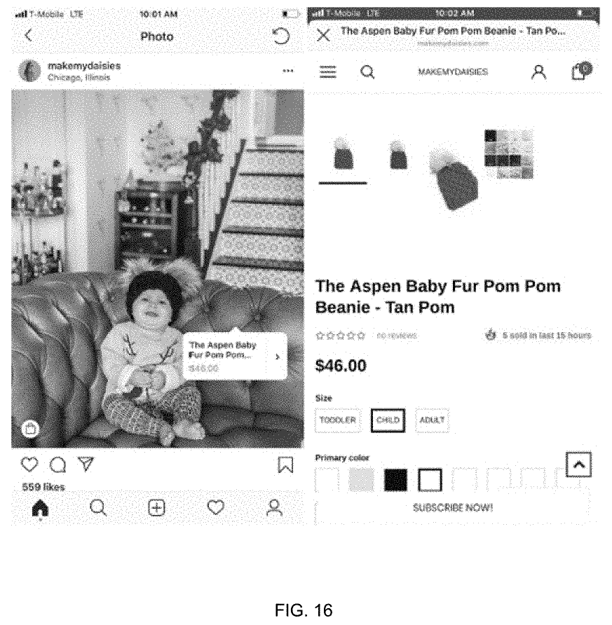

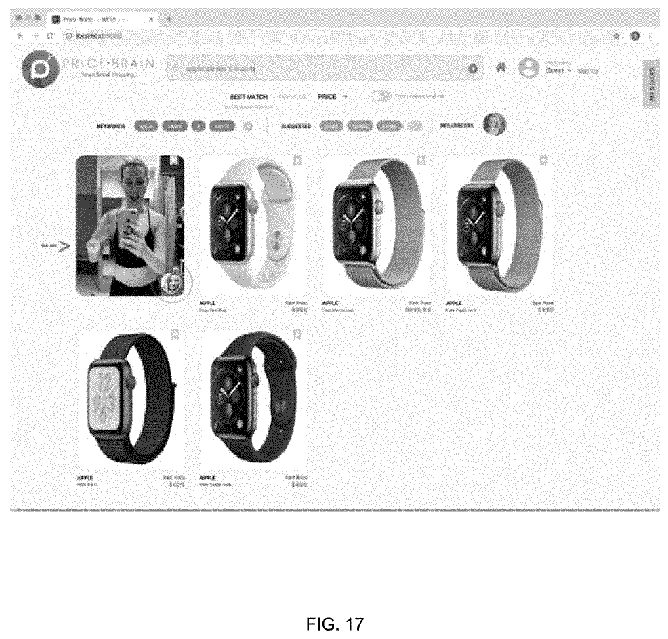

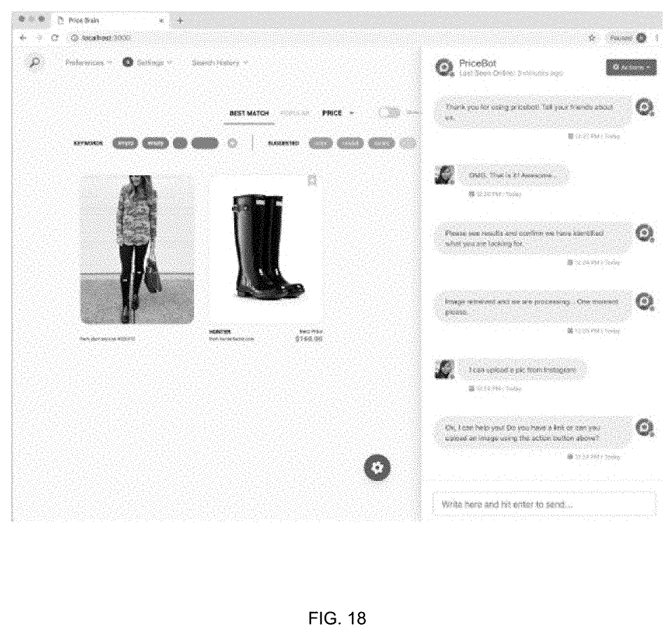

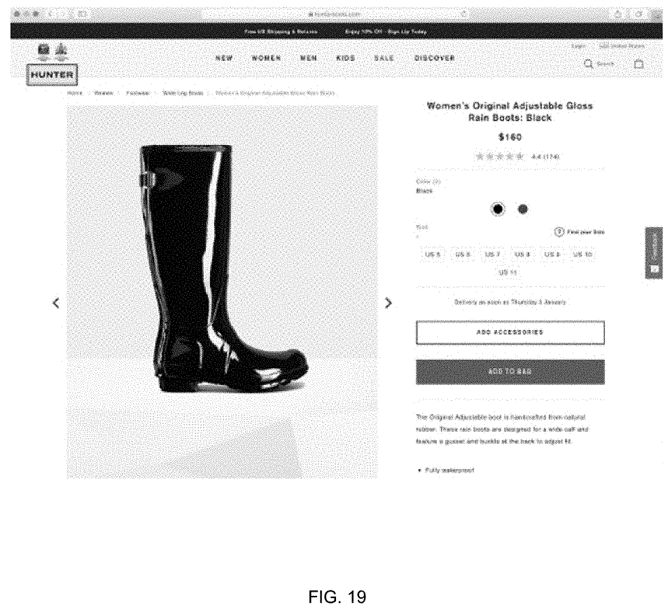

The end result from a client perspective is a small device (e.g., a RASPBERRY PI® 3 single-board computer) connected to a touch-screen monitor that displays scrolling product pricing in real-time. One exemplary user interface is depicted in FIG. 9. The client can change a product feed by selecting a drop down to switch to different “store”. The client can change a product price by touching a product (reflected by the rectangular outline in the first row of FIGS. 9A and 7B), which will change in the “store” as seen in FIG. 9B and the application product model. An API can update the product on the client's e-commerce site.

### Exemplary Workflow 2

Assume that a user wishes to upload a photograph onto a social media account. The photograph includes at least one product for purchase over the Internet, such as a dress worn by the subject of the photograph.

The user selects the photograph (e.g., via a graphical user interface), which may already be stored locally on a user computer, to upload to a social media account. The user may initially provide (e.g., through a website or portal) the photograph to the application discussed in the exemplary implementation above. In some cases, the photograph may already be posted on a social media account. For example, the user may have photos already uploaded to a social media account. The user may join an online extraction service (such as IMPORT.IO®). The user may grant the online extraction service access to the user's social media account, where the online extraction service may then activate a synchronization procedure to upload photos from the social media account to a platform or server managed by the online extraction service. Additionally, the application may also have access to the photographs via the uploading process.

The application may then scrape data from the photograph in order to begin building a model for any potential products the application may find. The application may extract data from the photograph and collect variants during extraction. The application may then input the extracted data into a model for the dress worn in the photograph. In this way, the application may identify the dress worn as well as generate the model that may be used to locate the dress from online sources.

The application may update the model for a product by performing an Internet search for the product. For example, the application may direct a script call to the GOOGLE® search engine. The information contained in the model associated with the dress in the photograph may be used by the application to generate a set of queries for the Internet search. For example, the application may convert descriptive terms contained in the model to search terms for the Internet search, such as dress, yellow, sundress, etc.

Based on the Internet search results, the application may find a URL corresponding to a website selling the product of interest contained in the photograph. In some cases, the application may find multiple URLs corresponding to different websites. After validating a URL (which can be used as a key to a record containing the product model match), the IMPORT.IO® service is called via an API script and a new extractor is automatically created. Data returned is pushed to GOOGLE® CLOUD DATAFLOW™ via an IMPORT.IO® API. The application may extract data from the corresponding websites, which may include a sales price for the product of interest. This extracted data may be added to the model for the product.

The application may generate a set of descriptive tags for any products of interest found based on the models built from the scraped data. For example, the application may find the dress worn by the subject of the photograph. Through the extracted data, the application may further determine various characteristics about the dress, such as color, style, and fabric. The application may use these characteristics as input and may generate descriptive tags as output, such as #yellow, #sundress, #cotton dress. In some cases, the application may compare the extracted or determined characteristics with a set of predefined key phrases (e.g., the #phrases may be stored in a database accessible by the application). In some cases, the client may manually input additional tags, which may also be added to the built model.

The application may then attach the descriptive tags to the photograph and upload the photograph to the social media account. Various social media accounts on platforms such as TWITTER® and PINTEREST® may be used and selected based on client preference. Thus, the photograph may be uploaded with various descriptive tags and with minimal client interaction.

The descriptive tags may allow for a social media user to find the product of interest from different websites over the Internet. In one example, the application may attach a descriptive tag including a URL to a website selling the product of interest. When clicked, the descriptive tag may forward the social media user to the website. Additionally or alternatively, the descriptive tag may include an image of the product of interest (e.g., a Smart Pin while using the PINTEREST® platform). The image of the product may appear over top of the photograph in certain situations, such as when the social media user clicks the portion of the photograph that displays the product interest, or when the social media user hovers a mouse pointer icon over the portion of the photograph for a predetermined amount of time. For example, a social media user can place a mouse pointer icon over the dress of the photograph. After the predefined amount of time (e.g., 1 second), an image of the dress appears over top of the photograph. The image of the dress may be a copy of photograph of the dress used by a website selling the dress. By clicking on the overlaid image of the dress, the social media user may be forwarded to the corresponding seller's webpage for the dress.

In some cases, a descriptive tag may be generated for a corresponding video rather than the photograph the product was found to be in. For example, the application may generate a descriptive tag for the dress and may store the tag for a video. The user may select the tag and attach the tag to a point in the video determined by the user. When a social media user views the video, the tag may allow the social media user to access the selling website corresponding to the tag. For example, the application may generate a tag that enables a swipe-up function during an INSTAGRAM® Story.

Additionally or alternatively, the photograph may be uploaded to and stored by an extraction service database, such as a database managed by IMPORT.IO®. The extraction service database may also store the built models corresponding to the products found within the photograph. In some embodiments, another user may access the extraction server database (e.g., through a website or portal managed by IMPORT.IO®), which may compile a set of photographs and their associated models.

The other user may search for a product of interest, such as by typing in keywords describing the product and through a graphical user interface. The application may compare the search with the information contained within the models, and may return a set of associated photographs.

In some cases, the keywords provided may be received by the application and used for uploading electronic advertisements to the other user's browser session. For example, the application may receive a set of keywords from the other user for searching for a product of interest. The application may compare the keywords to a set of stored words and variables (e.g., stored in a database managed by the extraction service). The application may, based on the comparison, select one or more electronic advertisements and may upload the advertisements to the extraction service webpage or portal that the other is currently visiting. This may allow the application to select user-specific advertisements to be uploaded in real-time based on user-provided phrases.

The other user may select one of the photographs (e.g., via clicking) presented on the webpage or portal, and the application may run an Internet search. For example, the application may direct a script call to the GOOGLE® search engine. The information contained in the model associated with the selected photographed may be used by the application to generate a set of queries for the Internet search. For example, the application may convert descriptive terms contained in the model to search terms for the Internet search.

Based on the Internet search results, the application may find a URL corresponding to a website selling the product of interest contained in the photograph. In some cases, the application may find multiple URLs corresponding to different websites. After validating a URL (which can be used as a key to a record containing the product model match), the IMPORT.IO® service can be called via an API script and a new extractor can be automatically created. Data returned can be pushed to GOOGLE® CLOUD DATAFLOW™ via an IMPORT.IO® API. The application may extract data from the corresponding websites, which may include a sales price for the product of interest.

The application may present the search results to the other user. In some cases, the application may filter the results to include a subset of results for the other user to view. A new “store” can be created on-the-fly (e.g., using the SHOPIFY® service) with product data gathered from the above process with product variants such as URL referrer and product price and can be displayed. The other user may be able to select a result, and may be forwarded to the corresponding website.

### Client Perspective of Exemplary Workflow 2

As discussed above, Exemplary Workflow 2 may provide a client with a seamless and efficient method for automated uploading of products of interest to a social media platform. The client may initiate the process by accessing a webpage or portal managed by the extraction service. In some cases, the client may grant access to a social media account held by the client to the extraction service. For example, the client may enter into an agreement with the extraction service company that results in the granted access.

After accessing the portal or webpage, the client may upload a photograph to the portal or webpage. In some cases, photograph may be uploaded automatically from the client's social media account due to the granted access discussed above (e.g., a synchronization function run by the extraction service).

In return, the client may receive back from the extraction service the photograph with attachable social media tags, which may then be either automatically or manually uploaded to the client's social media account. The social media tags are described in further detail in the exemplary workflows provided. However, in some cases, the social media tags may provide for a third party user to access a website selling a product of interest contained in the photograph. If a third party user clicks on the presented social media tag, the third party user may be forwarded to the selling website.

Further, the selling website may be alerted that a third party user has used the social media tag to access the selling website. The selling website may account for the number of third party users that rely on the social media tag to access the selling website. The selling website may provide payment to the client based on the number of third party users relying on the social media tag of the client to access the selling website (e.g., the client or the extraction service having a contractual agreement for the client to display the product of interest).

Additionally, the application can implement a request for pay (RfP) capability. For example, the application can be granted access to a web payment platform (e.g., the FACEBOOK® web payment platform). The application and the web payment platform can communicate transaction commissions and third party user clicks associated with photographs or other data uploaded from the user. The web payment platform, based on the communicated information with the application, can then process and transfer fees to the user (e.g., based on a predetermined arrangement between the user and the web payment platform). Due to the integration of the application and RfP process, compensation to a user can occur in drastically reduced times (e.g., within a matter of minutes).

With RfP, insufficient funds is minimized. Further, fraud risk is mitigated due to the multi-factor authentication embedded in the RfP process. Sensitive payment credentials are not shared externally, but exchanged via tokens generated per transaction between web payment platform and application servers.

For online users, the ability to influence, earn, and be compensated on demand provides a much needed enhancement to the current model of waiting significant delays of receiving compensation from an affiliate partner. Thus, the uploading of a photograph with associated products and social media tags is performed automatically through the extraction service rather than manually by the client. As conventional product tagging platforms require the client or some other person to manually attach tags to uploaded photographs, this automation provides for an efficient and seamless process for identifying products in a photograph, as well as tagging and linking the products to associated selling websites.

### Exemplary Workflow 3

Assume that a user wishes to purchase online a product of interest, for example a pair of boots worn by a subject of a photograph. The user may visit a website or portal managed by an extraction service entity, such as IMPORT.IO®. A bot utilizing artificial intelligence (AI) may be launched on the website or portal. The bot may identify text and/or images to retrieve products of interest. The bot may be powered by a custom GOOGLE® Diagflow AI instance, which may be connected to an application of the extraction service and/or servers managed by the extraction service. The bot may additionally be trained to “hit” and “respond,” after a user uploads a photograph or submits keywords to the site. The user may upload a photograph that includes the product of interest to an extraction service site. The bot may be prompted to launch a scrape, through an application discussed above, of the photograph and build a model for the boots. The extraction service site may then run an Internet search. The information contained in the model associated with the selected photographed may be used by the application to generate a set of queries for the Internet search. For example, the extraction service site may convert variants extracted from the photograph into search terms for the Internet search.

Based on the Internet search results, the application may find a URL corresponding to a website selling the product of interest contained in the photograph. In some cases, the application may find multiple URLs corresponding to different web sites. The application may extract data from the corresponding websites, which may include a sales price for the product of interest.

The application may present the search results to the user. In some cases, the application may filter the results to include a subset of results for the user to view. The user may be able to select a result, and may be forwarded to the corresponding website.

In some cases, similar to the process discussed in Exemplary Workflow 2, keywords provided by a user may be received by the application and used for uploading electronic advertisements to the other user's browser session. For example, the application may receive a set of keywords from the other user for searching for a product of interest. The application may compare the keywords to a set of stored words and variables (e.g., stored in a database managed by the extraction service). The application may, based on the comparison, select one or more electronic advertisements and may upload the advertisements to the extraction service webpage or portal that the other is currently visiting. This can allow the application to select user-specific advertisements to be uploaded in real-time based on user-provided phrases.

### User Perspective of Exemplary Workflow 3

Exemplary Workflow 3 can provide a user with automated identification of products contained in a photograph and avenues for purchasing a contained product. The user can initiate the process by visiting the extraction service portal or webpage. The portal or webpage can automatically prompt a message for the user based on the user access. The user can have a “conversation” with the portal or webpage, where the user receives an automated message based on a message written by the user. The user can be prompted to provide a photograph including a product of interest. The user can provide the photograph (e.g., via uploading, transferring, granting access to a stored photo, etc.) to the portal or webpage, and the user can receive in response a different photograph(s) containing the product of interest. The different photographs can also include other information, such as a selling vendor's information, the name and/or product identification information (e.g., SKU number), and the cost of purchasing the product from the corresponding vendor. The user can click on one of the photographs, and the user can be redirected to the corresponding vendor's webpage or the product. Like discussed above with reference to Client Perspective of Exemplary Workflow 2, the vendor webpage can account for the number of users that are forwarded to the webpage by the photographs presented by the extraction service.

The identification of products of interest and the determination of different avenues of purchase of the interested products is automated and provided by the extraction service. This automation provides the user with an efficient and seamless process for identifying and purchasing a product the user is interested in.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A computer-implemented method of providing an integrated social media and shopping environment, the computer-implemented method comprising:
receiving via a computer a photographic image comprising at least one product;
generating a computer-implemented model of the photographic image on the computer;
training a machine learning estimator using the computer-implemented model;
generating a set of social media tags corresponding to the at least one product based on the training;
storing an association between the set of social media tags and the photographic image; and
uploading the photographic image and the association to a social media platform.

2. The computer-implemented method of claim 1, wherein training the machine learning estimator further comprises:
extracting data from the photographic image;
determining a set of characteristics of the at least one product based on the extracted data from the photographic image; and
updating the generated computer-implemented model based on the set of characteristics.

3. The computer-implemented method of claim 2, wherein the extracted data comprises a set of key-value-pair nodes corresponding to the at least one product.

4. The computer-implemented method of claim 2, wherein generating the set of social media tags is based at least in part on the determined set of characteristics.

5. The computer-implemented method of claim 4, wherein generating the set of social media tags further comprises:
comparing the determined set of characteristics to a set of predefined keywords.

6. The computer-implemented method of claim 2, wherein updating the generated computer-implemented model further comprises:
customizing at least one extractor script managed by the computer-implemented model.

7. The computer-implemented method of claim 1, wherein the photographic image is received from a social media account managed by a user.

8. The computer-implemented method of claim 7, wherein the photographic image is downloaded from the social media account based on an activation of a synchronization procedure for the social media account.

9. The computer-implemented method of claim 1, further comprising:
controlling a search engine to obtain a plurality of Internet search results based on one or more queries containing information from the updated computer-implemented model;
controlling the machine learning estimator to generate a probability that the plurality of Internet search results relate to the at least one product in the photographic image;
if the probability exceeds a pre-defined threshold, extracting data including a price from the Internet search result; and
storing the extracted data from the Internet search result, including the price and a uniform resource locator (URL), in the computer-implemented model.

10. The computer-implemented method of claim 9, wherein generating the set of social media tags comprises:
generating at least one social media tag comprising at least a forwarding link to a webpage selling the at least one product, a visual representation of the at least one product, or a combination thereof.

11. The computer-implemented method of claim 10, where the visual representation is displayed over the uploaded photographic image when a social media user hovers a mouse pointer icon over the at least one product contained in the uploaded photographic image.

12. The computer-implemented method of claim 9, wherein at least one social media tag comprises a swipe-up function providing access to a website selling the at least one product, the method further comprising:
attaching the swipe-up function to a video uploaded to the social media platform.

13. A computer-implemented method of providing an integrated social media and shopping environment, the computer-implemented method comprising:
receiving via a computer, identity information corresponding to at least one product;
generating a computer-implemented model of the at least one product based on the identity information and on the computer;
training a machine learning estimator using the computer-implemented model;
controlling a search engine to obtain a plurality of Internet search results based on one or more queries containing information from the updated computer-implemented model;
controlling the machine learning estimator to generate a probability that the plurality of Internet search results relate to the at least one product;
if the probability exceeds a pre-defined threshold, extracting data including a price from the Internet search result;
storing the extracted data from the Internet search result, including the price and a uniform resource locator (URL), in the computer-implemented model; and
generating a graphical user interface displaying representations of at least one selected from the group consisting of: a photographic image, a price, and a vendor for the at least one product.

14. The computer-implemented method of claim 13, further comprising:
transmitting a predefined communication to a user based on the user activating a portal or webpage managed by the computer.

15. The computer-implemented method of claim 14, further comprising:
receiving a response from the user; and
communicating with the user via a set of predefined communications based on the received response.

16. The computer-implemented method of claim 15, wherein at least one communication from the user comprises the received identity information for the at least one product.

17. The computer-implemented method of claim 15, further comprising:
selecting at least one electronic advertisement based on the received response or communications from the user; and
uploading the at least one selected electronic advertisement to the portal or webpage managed by the computer.

18. The computer-implemented method of claim 13, wherein the method is implemented by at least an artificial intelligence (AI)-based web bot, wherein the AI-based web bot is managed by the computer.

19. The computer-implemented method of claim 13, wherein training the machine learning estimator further comprises:
extracting data from the identity information;
determining a set of characteristics of the at least one product based on the extracted data from the identity information; and
updating the generated computer-implemented model based on the set of characteristics.

20. The computer-implemented method of claim 13, further comprising:
updating the model by periodically extracting data from Internet search results.
